(19) United States
(12) Patent Application Publication
(10) Pub. No.: US 2010/0015349 A1
(43) Pub. Date: Jan. 21, 2010

(54) MARINE ANTIFOULANT COATING

(76) Inventor: Larry Weidman, Overland Park, KS (US)

Correspondence Address: HOVEY WILLIAMS LLP, 10801 Mastin Blvd., Suite 1000, Overland Park, KS, 66210, US

(21) Appl. No.: 12/564,601

(22) Filed: Sep. 22, 2009

Related U.S. Application Data
(63) Continuation-in-part of application No. 11/778,193, filed on Jul. 16, 2007.

(51) Int. Cl. C09D 5/16; B05D 1/04

(52) U.S. Cl. 427/447; 523/122

(57) ABSTRACT

A protective coating applied to the underwater portion of a marine vessel operable to inhibit the growth of marine foulants. The coating comprises a polymer, a marine biocide, a preservative, a coloring agent, and optionally an antimicrobial agent. In certain embodiments, the marine biocide, preservative, the coloring agent, and optional antimicrobial agent are chemically bonded with the polymer thereby significantly reducing the ability of the biocide, preservative, the coloring agent, and antimicrobial agent to leach from the coating into the surrounding environment.

### RELATED APPLICATIONS

The present application is a continuation-in-part patent application and claims priority benefit, with regard to all common subject matter, to earlier-filed U.S. non-provisional patent application entitled “MARINE ANTIFOULANT COATING”, Ser. No. 11/778,193, filed Jul. 16, 2007. The identified earlier-filed patent application is incorporated into the present application by reference.

### BACKGROUND OF THE INVENTION

1. Field of the Invention

Embodiments of the present invention relate to a coating that is applied to a surface. More particularly, embodiments of the present invention relate to a protective coating that is applied to the underwater portion of a marine vessel so as to inhibit the growth of marine foulants.

2. Description of the Related Art

Marine vessels that reside in a water environment over certain lengths of time can accumulate biological growth, known as foulants, on those surfaces that are in contact with the water. Diverse species of hard and soft fouling organisms, such as barnacles, zebra mussels, algae, and slime, form colonies on the underwater surfaces of the vessel, particularly when a vessel is docked, because each requires a permanent anchorage in order to mature and reproduce. Marine growth fouling adds weight to a ship, increases the amount of fuel consumed, and reduces its speed.

Historically, to combat the growth of marine foulants, the underwater surfaces of ships have been coated with antifoulant paints, which often include toxic materials to inhibit biological growth. The antifoulant paints may degrade and break down over time, releasing the toxic materials from the marine vessel into the surrounding water. These toxic materials may include volatile organic compounds (VOCs) and hazardous air pollutants (HAPs). The International Maritime Organization and the United States Environmental Protection Agency have enacted regulations and standards that restrict the emission of VOCs and HAPs from antifoulant paints. The decomposition and break down of the antifoulant paint results in reduced efficacy of the protection afforded by the antifoulants, thereby requiring reapplication of the paint in a relatively short time. Thus, a coating material is required which may be colored and can be applied to the underwater surfaces of a marine vessel that also repels the growth of fouling organisms on such surfaces and has an extended lifetime without releasing significant amounts of toxic materials into the environment.

### SUMMARY OF THE INVENTION

Embodiments of the present invention solve the above-mentioned problems and provide a distinct advance in the art of coatings applied to a surface. More particularly, embodiments of the invention provide a colorable protective coating applied to the underwater portion of a marine vessel operable to inhibit the growth of marine foulants. Furthermore, the coating does not degrade significantly over time which leads to a longer effective lifetime and a greatly reduced emission of toxic materials as compared with conventional antifoulant paints.

Various embodiments of the present invention provide an antifoulant coating comprising a polymer that adheres to a surface of a marine vessel that contacts water, a preservative and a marine biocide. In certain embodiments, the preservative and marine biocide are chemically bonded to the polymer so as to prevent leaching of the preservative and/or biocide into the surrounding marine environment.

In another embodiment, a method of forming a marine antifoulant coating is provided. The method comprises forming a mixture comprising particles of a polymer, a marine biocide, a preservative, and a coloring agent. The mixture is heated to a temperature above the glass transition temperature of the polymer thereby forming a flowable mixture comprising the polymer having particles of the biocide and preservative dispersed therein. A variable electric field is applied to the heated mixture to alter the orientation of the polymer and the particles of biocide and preservative relative to each other.

In yet another embodiment, a method of applying a marine antifoulant coating to a surface of a marine vessel is provided. The method comprises injecting a heated blended mixture comprising a polymer, a marine biocide, and a preservative into a plasma stream. The plasma stream and heated blended mixture are enshrouded with a shielding gas to prevent contamination of the heated blended mixture. The plasma stream and heated blended mixture are directed onto the marine vessel surface whereby the heated blended mixture becomes adhered to the surface.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the preferred embodiments.

### DETAILED DESCRIPTION OF THE PREFERRED EMBODIMENTS

The embodiments illustrated in the following detailed description are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

The coating is generally operable to inhibit the growth of marine fouling organisms on the underwater portion of a marine vessel by repelling the marine organisms when they contact the coating. In various embodiments, the coating also reduces the ability of fouling organisms to adhere to the coated marine vessel surface. Some growth of organisms on the coating may occur, particularly when the vessel is idle, but the organisms detach and slough off as the vessel begins moving through the water. The coating prevents the fouling organisms from strongly adhering to the marine vessel so that the motion of water across the surface of the coating serves as a rinsing action to clean the surface of any fouling growth. In addition, it is sometimes desired that the coating possess a certain color to match other features of the vessel, to meet government or military guidelines, or to achieve a general aesthetic. As a result, the coating may include a coloring agent. Accordingly, the percentage amounts of the other components may be adjusted to accommodate the coloring agent.

In various embodiments, the coating comprises a polymer, a marine biocide, a preservative, and a coloring agent. In other embodiments, the coating further comprises an antimicrobial agent.

The polymer component serves as a foundation for the antifoulant coating in which the other components of the coating are dispersed. Without desiring to be bound by any particular theory, it is believed that the polymer functions as a matrix to which the other components are chemically bonded. Furthermore, it is believed that the preservative and marine biocide may be covalently bonded to the polymer, although certainly it is within the scope of the invention for these bonds to be of an ionic nature as well.

In any event, the polymer binds the preservative and marine biocide in the coating and helps to retain them against the target surface, such as the hull of a ship. The polymer may be a polyamide including various types of nylon such as nylon 11 or nylon 12, available under the name Vestosint® by Degussa of Düsseldorf, Germany. The polymer may also be an impact resistant powder coating resin, such as Surlyn®, Abcite® X60 or Abcite® X70 by DuPont of Wilmington, Del. In various embodiments, the listed polymers may be polar in nature. Generally, the polymer presents the characteristics of increased adhesion to various substrates (particularly metal), high impact resistance, and high resistance to degradation.

In some embodiments, the polymer may include the coloring agent or may be manufactured to possess a desired color. An example of a colored polymer is the nylon 12 in black manufactured by Degussa.

In various embodiments, the polymer may also include a fluoropolymer, such as polytetrafluoroethylene (PTFE), perfluoroalkoxy polymer resin (PFA), polyethylenetetrafluoroethylene (ETFE), or polyvinylidene fluoride (PVDF), or powdered silicone in combination with any of the polymers listed above. It is possible that the listed components are non-polar. These additive components are typically included to decrease the coefficient of friction of the antifoulant coating and would primarily be used in situations where the vessel is faster moving, thereby benefiting from a decreased drag on the ship.

Generally, the polymer is supplied in a powder form having average particle sizes ranging from about 20 microns (μm) to about 80 μm. In other embodiments, the polymer may be supplied in a nano-sized form wherein the average particle size is between about 25 nanometers (nm) to about 40 nm.

The polymer typically presents a glass transition temperature that is lower than the melting point of the other components included in the antifoulant coating. Thus, the polymer enters the glass transition phase and bonds with the other components before the other components begin to melt. Thus, the marine biocide and preservative are present as discrete particles dispersed within the polymer matrix. Additionally, the polymer is compatible with the target surface so as to adhere strongly thereto once applied. The glass transition temperature of the polymer may be within the range of about 176° F. to about 248° F.

The marine biocide generally comprises a metal component such as copper or silver. Biocides containing metal components are well known in the art. The biocide may be supplied as copper oxide (also known as cuprous oxide or Cu₂O), copper and silver coated hollow micro spheres, silver and copper-clad mica flake, or AgION™ antimicrobial by Agion of Wakefield, Massachusetts. Copper oxide is widely used and is available in several grades, Red Copper 97, Premium grade Purple 97N, and Lo-Lo Tint 97N. However, the marine biocide may comprise any single component listed or combinations thereof. The marine biocide may also include other conventional biocide components, preferably in powder form, that can bond with the polymer.

The marine biocide may be supplied in a micro-sized form, wherein the average particle size is from about 40 μm to about 60 μm, or a nano-sized form, wherein the average particle size is from about 25 nm to about 35 nm. As noted above, the biocide can continue to exist as a plurality of discrete particles dispersed within the polymer matrix once formed into the coating composition.

The preservative may comprise Vancide® 89, by R. T. Vanderbilt Company, Incorporated of Norwalk, Conn. The preservative is generally included to protect the polymer from degradation and breakdown due to bacterial growth. The preservative may also include other preservative components that can be supplied in a powder form and can bond with the polymer.

Generally, the preservative may be provided in a micro-sized form, wherein the average particle size is from about 20 μm to about 80 μm, or a nano-sized form, wherein the average particle size is from about 25 nm to about 40 nm.

The coloring agent may represent any color or shade and may comprise any pigment, tint, dye, or stain that is available in powder form. The coloring agent may be provided in a nano-sized form, wherein the average particle size is from about 10 nm to about 100 nm. Various embodiments may include carbon black pigment available from Degussa, CAS number 1333-86-4.

In various embodiments, the antifoulant coating may also include an antimicrobial agent, such as Irgaguard® or Irgarol® by Ciba of Tarrytown, New York, indium oxide or indium-tin oxide by Indium Corporation of Utica, New York, and NanoKlean™ by Envont Technologies of Chesterfield Township, Michigan. The antimicrobial agent may be included to provide additional protection against microbial growth that could cause staining or degradation of the antifoulant coating or that could lead to the growth of larger organisms. Typically, as the level of the antimicrobial is increased, the level of the preservative is decreased. Thus, there is a tradeoff between additional prevention of foulant growth and preservation of the polymer. The antimicrobial may be added depending on the characteristics of the water in which the vessel is anticipated to reside primarily. Furthermore, the antimicrobial agent is generally provided in a blendable powder form and is capable of bonding with the polymer.

It is possible that one or more of the polymer, the marine biocide, the preservative, and optionally the antimicrobial agent may present a net positive or negative electrical charge in order to aid with bonding of the components. It is also possible that the above components may present polar regions as opposed to a full charge.

In various embodiments, the antifoulant coating comprises from about 43% to about 67% by weight of the marine biocide, from about 28% to about 49% by weight of the polymer, from about 1% to about 5% by weight of the preservative, and from about 0.5% to about 1.5% by weight of the coloring agent. When present, the antimicrobial agent is present at a level of from about 2% to about 6% by weight. Also when present, the additive fluoropolymer or silicone powder is present at a level of from about 10% to about 20% by weight.

In other embodiments, the antifoulant coating comprises from about 53% to about 57% by weight of the marine biocide, from about 33% to about 39% by weight of the polymer, from about 2% to about 4% by weight of the preservative, and from about 0.9% to about 1.1% by weight of the coloring agent. When present, the antimicrobial agent is present at a level of from about 3% to about 5% by weight. Also when present, the additive fluoropolymer or silicone powder is present at a level of from about 10% to about 20% by weight.

In still other embodiments, the antifoulant coating comprises from about 50% to about 60% by weight of the marine biocide, from about 35% to about 43% by weight of the colored polymer, and from about 3% to about 5% by weight of the preservative. When present, the antimicrobial agent is present at a level of from about 2% to about 6% by weight. Also when present, the additive fluoropolymer or silicone powder is present at a level of from about 10% to about 20% by weight.

These components are generally supplied in a powder form with a particle sizes as described above. The polymer, the marine biocide, the preservative, the coloring agent, and optionally the antimicrobial agent and fluoropolymer or silicone powder are mixed in a blender to yield a uniform powder material. The blender may be cooled to prevent overheating and coagulation of the mixture.

A first exemplary mixture is created as follows. The total weight of the mixture may be 100 pounds. The polymer component comprises 37 pounds of polar polyamide nylon that has been precipitated in the form of round-shaped particles. The marine biocide component comprises 55 pounds of red cuprous oxide 97N premium grade, the preservative component comprises 3 pounds of Vancide® 89, and the coloring agent comprises 1 pound of carbon black pigment. The above components are placed in a water jacket-cooled Henschel blender and mixed at 3600 rpm for two minutes.

Next, the mixture is heated to a temperature sufficient to exceed the glass transition temperature of the polymer, and perhaps even the melting point of the polymer, but not great enough to melt the other components. Generally, the mixture is heated to between about 220° F. and about 275° F. Thus, the polymer becomes flowable and can bond with the other components. Generally, the biocide, the preservative, and the coloring agent do not bond with each other, but instead are dispersed within the polymer matrix. In certain embodiments, the components comprising the antifoulant coating form bonds with each other to produce a four-part structure, and in embodiments also comprising an antimicrobial agent, a five-part structure. In each instance, the biocide, preservative, coloring agent, and optional antimicrobial agent bond or interact directly with the polymer as opposed to each other.

The mixture may also be exposed to a variable electric field in which the components may have their radial velocity adjusted, be separated, reoriented, or otherwise manipulated in order to maximize the percentage of material that forms a four-part (or five-part) bonded structure. The variable electric field is generally applied to a confined space, such as a chamber through which the material passes, so that the motion of the components may be precisely controlled. For example, the electric field may be applied to the chamber so that the polymer is physically aligned in the proper orientation with the marine biocide, the preservative, the coloring agent, and, optionally the antimicrobial to form the four-part or five-part bonded structure.

Once the mixture is heated, the coating is injected into a plasma stream that is surrounded by a shielding gas to prevent contamination of the coating during transport to the target surface. The temperature of the coating must be maintained at or above the glass transition temperature of the polymer until the coating impacts the target surface (i.e., a portion of the surface of a marine vessel). However, if the coating becomes too warm, the bonds between the polymer and the other components may break thereby leading to the decomposition of the coating. Excessive temperatures may also lead to the formation of bonds between the marine biocide, the preservative, the coloring agent, and/or the antimicrobial thereby minimizing the effectiveness of the coating to prevent foulant growth. Further, if the coating cools before impacting the surface, its ability to adhere to the surface may be adversely affected. The coating may not evenly adhere to the surface thereby decreasing the lifetime of the coating.

In various embodiments, the coating may be applied to a primer coating comprising only the polymer if the target surface has some chemical or physical characteristics or possibly contaminants that may affect the adherence of the coating. A polymer primer coat generally increases the adherence of the antifoulant coating to the target surface.

In various embodiments, the resulting mixture is applied to a target surface using a high-velocity impact fusion plasma spray gun apparatus, such as the one disclosed in U.S. patent application Ser. No. 11/758,991, filed Jun. 6, 2007, which is herein incorporated by reference. For use with the plasma spray gun apparatus, the mixture is placed into a bin or hopper that is capable of supplying the mixture in a pressurized form to the spray gun, wherein the mixture is transformed into the antifoulant coating that is ready to be applied to a surface.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A marine antifoulant coating for application to a surface of a marine vessel said coating comprising:
a polymer;
a marine biocide;
a preservative that is chemically bonded with said polymer; and
a coloring agent.

2. The coating of claim 1, wherein said marine biocide comprises copper.

3. The coating of claim 1, wherein said polymer presents a particle size from about 20 microns to about 80 microns.

4. The coating of claim 1, wherein said marine biocide presents a particle size from about 40 microns to about 60 microns.

5. The coating of claim 1, wherein said preservative presents a particle size from about 20 microns to about 80 microns.

6. The coating of claim 1, wherein said marine biocide and preservative are dispersed within said polymer.

7. The coating of claim 1, wherein said polymer is chemically bonded with said marine biocide.

8. The coating of claim 1, wherein said coating further comprises an antimicrobial agent.

9. The coating of claim 1, wherein said coating further comprises at least one synthetic resin selected from the group consisting of fluoropolymers and silicone powder.

10. The coating of claim 9, wherein said fluoropolymer is selected from the group consisting of polytetrafluoroethylene, perfluoroalkoxy polymer resin, polyethylenetetrafluoroethylene, and polyvinylidene fluoride.

11. A marine antifoulant coating for application to a surface of a marine vessel said coating comprising:
between about 28% to about 49% by weight of a polymer;
between about 43% to about 67% by weight of a marine biocide;
between about 1% to about 5% by weight of a preservative that is chemically bonded with said polymer;
between about 0.5% to about 1.5% by weight of a coloring agent; and
between about 2% to about 6% by weight of an antimicrobial agent.

12. The coating of claim 11, wherein said coating further comprises at least one synthetic resin selected from the group consisting of fluoropolymers and silicone powder.

13. The coating of claim 12, wherein said fluoropolymer is selected from the group consisting of polytetrafluoroethylene, perfluoroalkoxy polymer resin, polyethylenetetrafluoroethylene, and polyvinylidene fluoride.

14. A method of forming a marine antifoulant coating, the method comprising the steps of:
a) forming a mixture comprising particles of a polymer, a marine biocide, a preservative, and a coloring agent;
b) heating said mixture to a temperature above the glass transition temperature of said polymer thereby forming a flowable mixture comprising said polymer having particles of said biocide and preservative dispersed therein; and
c) applying a variable electric field to said heated mixture to alter the orientation of said polymer and said particles of biocide and preservative relative to each other.

15. The method of claim 14, wherein said mixture comprises between about 28% to about 49% by weight of said polymer.

16. The method of claim 14, wherein said mixture comprises between about 43% to about 67% by weight of said marine biocide.

17. The method of claim 14, wherein said mixture comprises between about 1% to about 5% by weight of said preservative.

18. The method of claim 14, wherein said mixture comprises between about 0.5% to about 1.5% by weight of said coloring agent.

19. The method of claim 14, wherein said polymer, prior to being heated, presents a particle size of between about 20 microns to about 80 microns.

20. The method of claim 14, wherein said marine biocide presents a particle size of between about 40 microns to about 60 microns.

21. The method of claim 14, wherein said preservative presents a particle size of between about 20 microns to about 80 microns.

22. A method of applying a marine antifoulant coating to a surface of a marine vessel, said method comprising the steps of:
a) injecting a heated blended mixture comprising a polymer, a marine biocide, a preservative, and a coloring agent into a plasma stream;
b) enshrouding said plasma stream and heated blended mixture with a shielding gas to prevent contamination of said heated blended mixture; and
c) directing said plasma stream and said heated blended mixture onto said marine vessel surface, whereby said heated blended mixture becomes adhered to said surface.

23. The method of claim 22, wherein said heated blended mixture comprises between about 28% to about 49% by weight of said polymer, between about 43% to about 67% by weight of said marine biocide, between about 1% to about 5% by weight of said preservative, and between about 0.5% to about 1.5% by weight of said coloring agent.
